(19) United States
(12) Patent Application Publication
(10) Pub. No.: US 2013/0188121 A1
(43) Pub. Date: Jul. 25, 2013

(54) EYEGLASSES

(71) Applicant: Shun-Tien Yang, Tainan City (TW)

(72) Inventor: Shun-Tien Yang, Tainan City (TW)

(73) Assignee: All-Logic Int. Co., Ltd., Tainan City (TW)

(21) Appl. No.: 13/542,514

(22) Filed: Jul. 5, 2012

(30) Foreign Application Priority Data
Jan. 19, 2012 (TW) 101201368

(51) Int. Cl. G02C 5/20

(52) U.S. Cl. 351/115

(57) ABSTRACT

A pair of eyeglasses includes a lens unit and a pair of temple members. The lens unit includes a pair of endpieces horizontally spaced apart from each other. Each of the temple members includes a temple and a guiding mechanism. The temple includes a pivoting part pivoted to a corresponding one of the endpieces, and is pivotable upward and downward with respect to the corresponding one of the endpieces between an extending position, where the temple extends backwardly away from the lens unit, and a folded position, where the temple is disposed behind and extends proximate to the lens unit. The guiding mechanism is for guiding and limiting the temple to pivot between the extending position and the folded position.

### CROSS-REFERENCE TO RELATED APPLICATION

This application claims priority of Taiwanese Application No. 101201368, filed on Jan. 19, 2012.

### BACKGROUND OF THE INVENTION

1. Field of the Invention

The present invention relates to a pair of eyeglasses, more particularly to a pair of eyeglasses occupying a relatively small space when in a folded state.

2. Description of the Related Art

Currently, in order to easily carry a pair of conventional eyeglasses, the conventional eyeglasses include a lens unit having a pair of endpieces, and a pair of temple members pivoted to the endpieces of the lens unit through a pair of screws extending vertically through the endpieces, respectively. The temple members are pivotable toward the lens unit to a folded position, where the temple members are disposed behind the lens unit and a space occupied by the conventional eyeglasses is reduced for easily carrying the conventional eyeglasses. However, since the temple members pivot horizontally with respect to the lens unit, there is still a substantial distance between the temple members and the lens unit when the temple members are disposed at the folded position. Hence, a further reduction in the space occupied by the conventional eyeglasses when the temple members are disposed at the folded position is desirable.

Moreover, the greater the curvature of the temple members, the more stable will be the conventional eyeglasses when being worn by a user. Nevertheless, the greater curvature of the temple members will result in a larger space occupied by the conventional eyeglasses.

### SUMMARY OF THE INVENTION

Therefore, an object of the present invention is to provide a pair of eyeglasses occupying a relatively small space when in a folded state.

Accordingly, a pair of eyeglasses of the present invention comprises a lens unit and a pair of temple members. The lens unit includes a pair of endpieces horizontally spaced apart from each other. Each of the temple members includes a temple and a guiding mechanism. The temple includes a pivoting part pivoted to a corresponding one of the endpieces, and is pivotable upward and downward with respect to the corresponding one of the endpieces between an extending position, where the temple extends backwardly away from the lens unit, and a folded position, where the temple is disposed behind and extends proximate to the lens unit. The guiding mechanism is for guiding and limiting the temple to pivot between the extending position and the folded position.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a preferred embodiment of a pair of eyeglasses according to the present invention;

FIG. 2 is an enlarged fragmentary exploded perspective view of the eyeglasses for illustrating assembly relationship between a lens unit and a temple member of the eyeglasses;

FIG. 3 is a top view of the eyeglasses of the preferred embodiment, where a pair of temples are disposed at an extending position;

FIG. 4 is a cross-sectional view taken along a line IV-IV in FIG. 3;

FIG. 5 is a cross-sectional view taken along a line V-V in FIG. 3;

FIG. 6 is a top view of the eyeglasses of the preferred embodiment, where the temples are disposed at a folded position; and

FIG. 7 is a cross-sectional view taken along a line VII-VII in FIG. 6.

### DETAILED DESCRIPTION OF THE PREFERRED EMBODIMENT

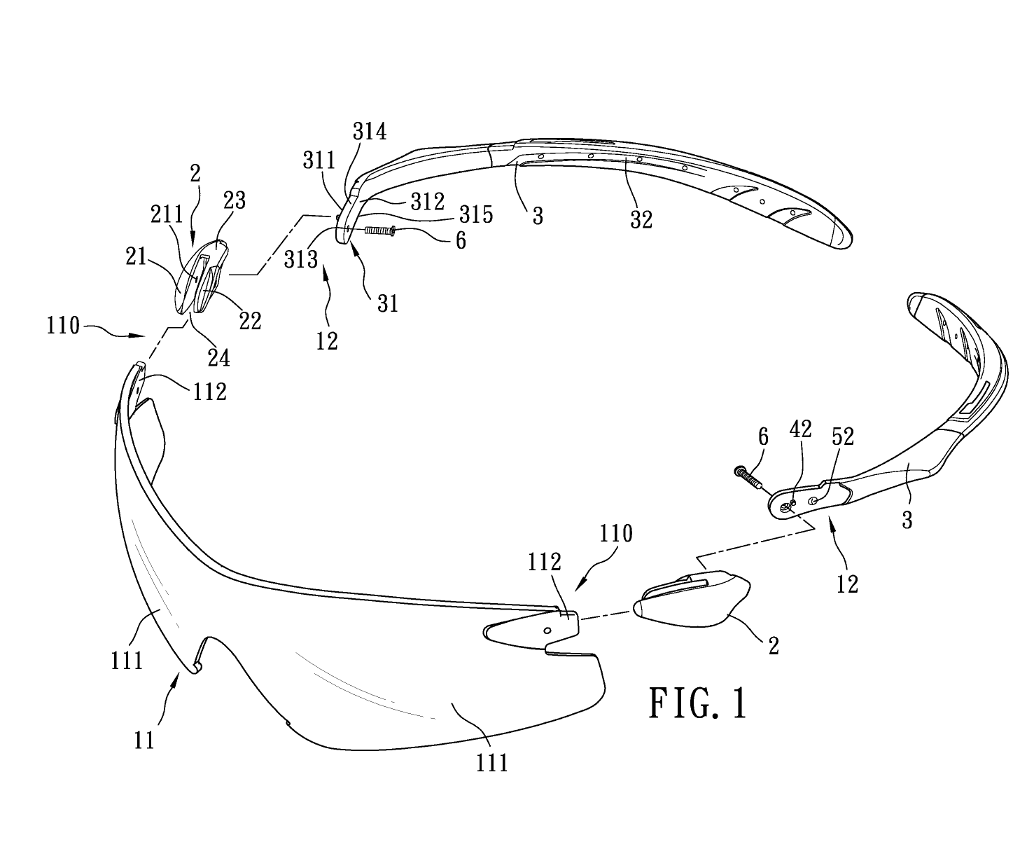

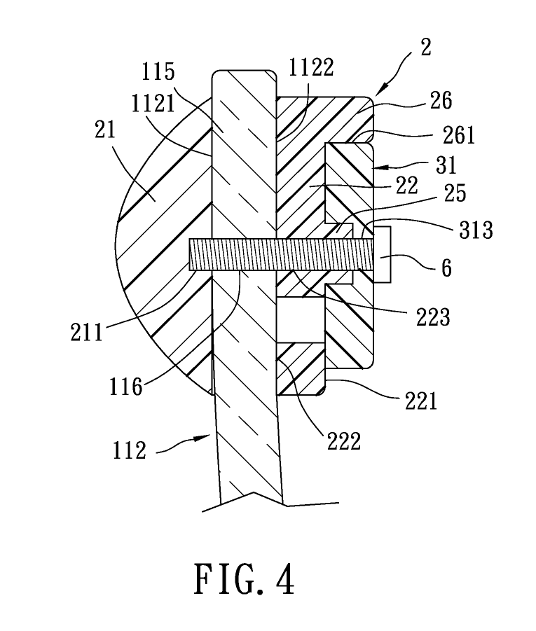

Referring to FIGS. 1 to 4, a preferred embodiment of a pair of eyeglasses of this invention includes a lens unit 11 and a pair of temple members 12. In practice, the lens unit 11 may have a frame or a half frame, or may be frameless as shown in this embodiment. The lens unit 11 includes a pair of lenses 111 with bilateral symmetry, and a pair of endpieces 110 disposed respectively at rear portions of the lenses 111 and horizontally spaced apart from each other. Each of the endpieces 110 includes a plate portion 112, and a connecting element 2 connected to the plate portion 112. The plate portion 112 is formed with a lower notch 113 facing rearward and an upper notch 114 facing upward, and includes an insertion plate 115 that is disposed between the lower notch 113 and the upper notch 114 and that is formed with a first through hole 116 extending horizontally through the insertion plate 115. The plate portion 112 has an outer side 1121 and an inner side 1122.

The connecting element 2 includes an outer wall 21, an inner wall 22, and an interconnecting wall 23. The outer wall 21 and the inner wall 22 have respective rear ends, and the interconnecting wall 23 interconnects the rear ends of the outer wall 21 and the inner wall 22 and cooperates with the outer wall 21 and the inner wall 22 to define a clamping groove 24. The outer wall 21 and the inner wall 22 are spaced apart from each other and are disposed respectively at the outer side 1121 and the inner side 1122 of the plate portion 112 so as to sandwich the plate portion 112 therebetween. In particular, the insertion plate 115 of the plate portion 112 is inserted into the clamping groove 24. The outer wall 21 is formed with a threaded hole 211 in spatial communication with the clamping groove 24. The inner wall 22 has an inner surface 221 and an outer surface 222 that abuts against the inner side 1122 of the plate portion 112, and is formed with a second through hole 223 extending through the inner surface 221 and the outer surface 222.

The connecting element 2 further includes an annular wall 25 projecting inwardly from the inner surface 221 of the inner wall 22 and surrounding the second through hole 223, and a blocking wall 26 projecting inwardly from the inner surface 221 of the inner wall 22. The blocking wall 26 includes a blocking surface 261 facing downward and having a rear segment 262 and a front segment 263. The rear segment 262 is substantially horizontal and is adjacent to the interconnecting wall 23, and the front segment 263 extends forwardly and downwardly from the rear segment 262.

In this embodiment, each of the temple members 12 includes a temple 3 pivotable upward and downward with respect to the connecting element 2, a guiding mechanism 4 and a positioning mechanism 5 that are disposed between the connecting element 2 and the temple 3, and a pivoting element 6 extending horizontally through and interconnecting the temple 3, and the connecting element 2 and the plate portion 112 of the corresponding one of the endpieces 110.

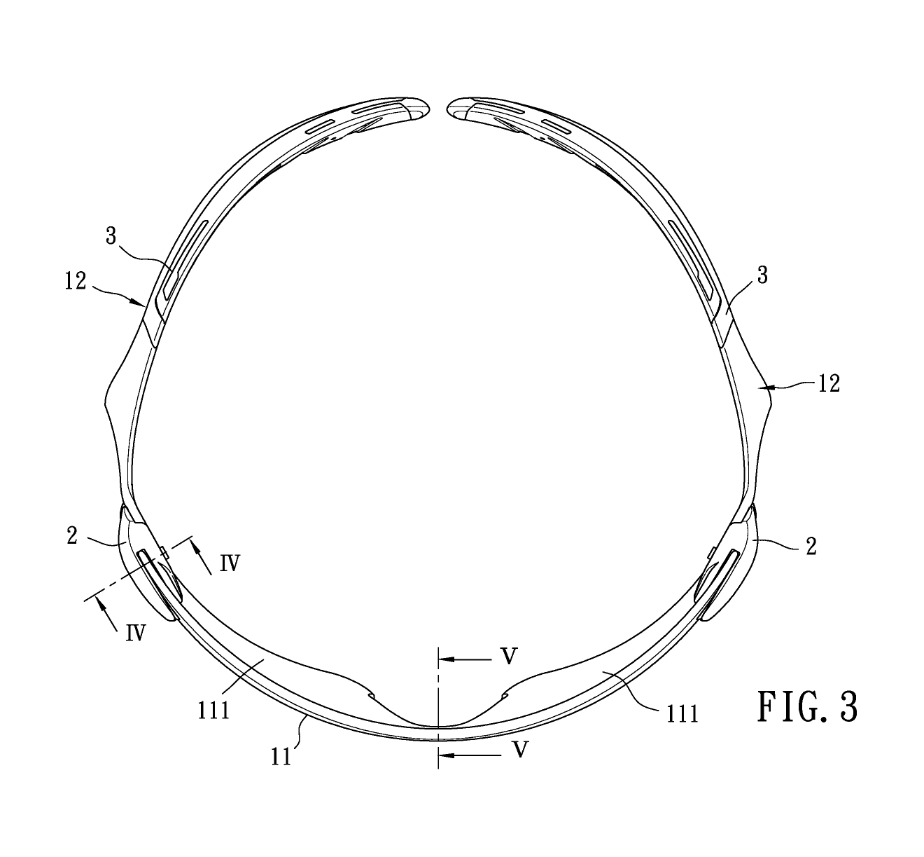

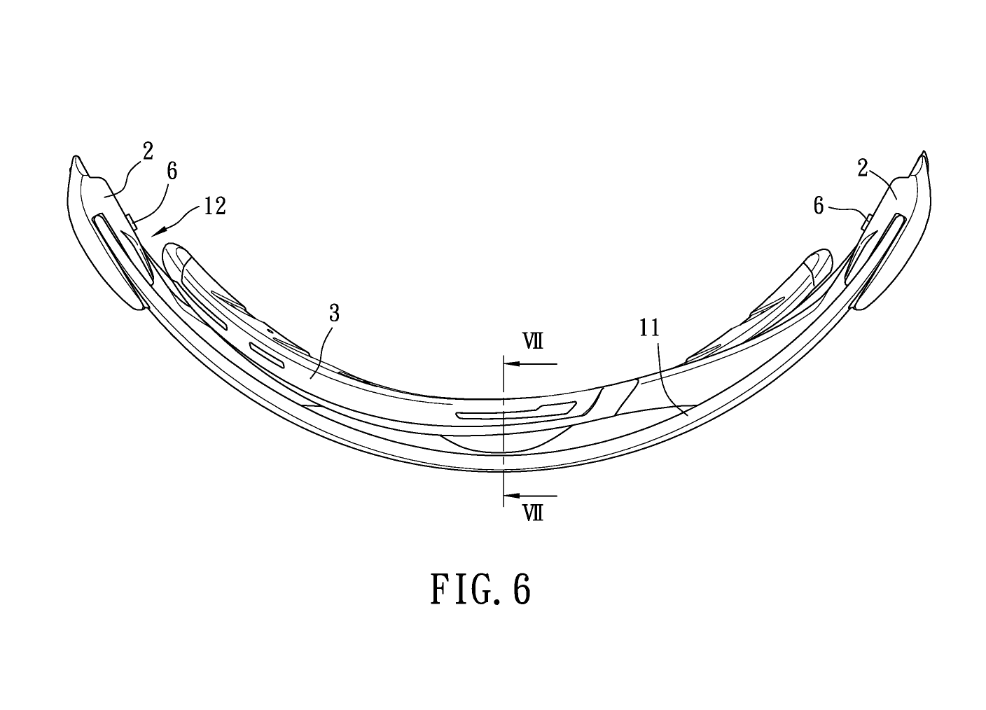

The temple 3 has a curvature substantially matching with a curvature of the lens unit 11, and is pivotable upward and downward with respect to the connecting element 2 between an extending position (as shown in FIG. 3), where the temple 3 extends backwardly from the connecting element 2 away from the lens unit 11, and a folded position (as shown in FIG. 6), where the temple 3 is disposed behind and extends proximate to the lens unit 11. The temple 3 includes a pivoting part 31 facing the inner surface 221 of the inner wall 22 of the connecting element 2 and pivoted to the inner wall 22 of the connecting element 2, and a bend part 32 extending from the pivoting part 31 and having a thickness greater than a thickness of the pivoting part 31. Preferably, the thickness of the pivoting part 31 ranges from 1 mm to 3 mm. The pivoting part 31 includes an abutting surface 311 abutting against the inner surface 221 of the inner wall 22 of the connecting element 2, an inside surface 312 facing inward, and a top surface 314 and a bottom surface 315 vertically opposite to each other. The top surface 314 abuts against the rear segment 262 of the blocking surface 261 of the blocking wall 26 when the temple 3 is at the extending position, and the bottom surface 315 abuts against the front segment 263 when the temple 3 is at the folded position. The pivoting part 31 is formed with a third through hole 313 extending through the abutting surface 311 and the inside surface 312.

The guiding mechanism 4 is configured for guiding and limiting the temple 3 to pivot between the extending position and the folded position, and includes a guiding groove 41 and a pin 42. In this embodiment, the guiding groove 41 is disposed at the inner wall 22 of the connecting element 2 of a corresponding one of the endpieces 110 and the pin 42 is disposed at the pivoting part 31 of the temple 3. It should be noted that, in other embodiments, the guiding groove 41 may be disposed at the pivoting part 31 of the temple 3 and the pin 42 may be disposed at the inner wall 22 of the connecting element 2. The guiding groove 41 is curved partially around the second through hole 223, and includes a first limiting end 413, a second limiting end 414 vertically opposite to the first limiting end 413, and a middle part 412 disposed between and in spatial communication with the first limiting end 413 and the second limiting end 414. The first limiting end 413 and the second limiting end 414 have a diameter slightly greater than a width of the middle part 412. The pin 42 has a diameter approximately equal to the diameter of the first and second limiting ends 413, 414, and engages the first and second limiting ends 413, 414 when the temple 3 is at the extending position and the folded position, respectively.

The positioning mechanism 5 includes a recess 51 disposed at the inner surface 221 of the inner wall 22 of the connecting element 2 of the corresponding one of the endpieces 110, and a protrusion 52 disposed at the abutting surface 311 of the pivoting part 31 of the temple 3. In other embodiments, the recess 51 may be disposed at the abutting surface 311, and the protrusion 52 may be disposed at the inner surface 221. The protrusion 52 is configured to engage the recess 51 when the temple 3 is at the extending position.

For assembling the eyeglasses of this embodiment, first, the connecting element 2 is connected to the plate portion 112. In particular, the insertion plate 115 of the plate portion 112 is inserted into the clamping groove 24. At this time, the first through hole 116 in the insertion plate 115, the threaded hole 211 in the outer wall 21 of the connecting element 2, and the second through hole 223 in the inner wall 22 of the connecting element 2 are registered with one another. Subsequently, the pivoting part 31 of the temple 3 is disposed at the inner wall 22 of the connecting element 2, and the abutting surface 311 abuts against the inner surface 221 of the inner wall 22. At this time, the third through hole 313 in the pivoting part 31 is registered with the second through hole 223 in the inner wall 22 of the connecting element 2, and the annular wall 25 extends into the third through hole 313. Then, the pivoting element 6 (e.g., a screw in this embodiment) extends through the third through hole 313, the second through hole 223 and the first through hole 116 in sequence and is screwed into the threaded hole 211 such that each of the temple members 12 may be connected to the lens unit 11.

In other embodiments, the connecting element 2 may be connected to the plate portion 112 in a different manner, and accordingly, the pivoting element 6 may only extend through the third through hole 313 in the pivoting part 31 and may threadedly engage with the second through hole 223 in the inner wall 22. It should be noted that, in other cases where the lens unit 11 has a frame or a half frame, the connecting element 2 may be integrally formed with the frame or the half frame of the lens unit 11.

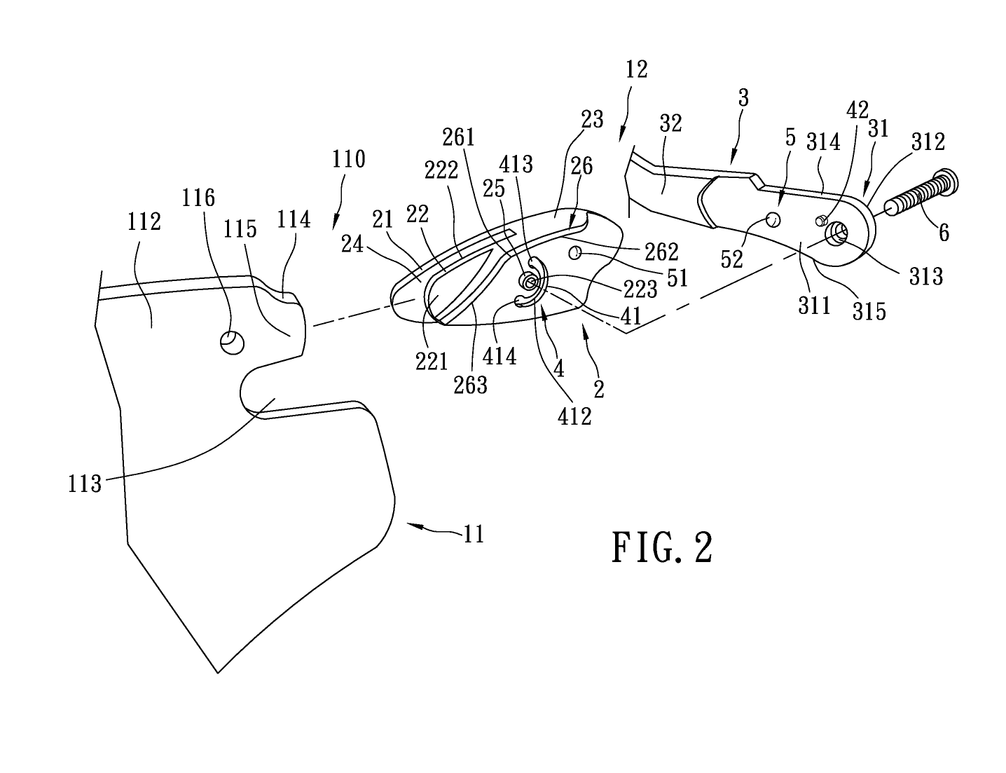

Referring to FIGS. 2, 3 and 5, the top surface 314 of the pivoting part 31 of the temple 3 abuts against the rear segment 262 of the blocking surface 261 of the blocking wall 26 when the temple 3 is at the extending position. Moreover, at the extending position, the pin 42 of the guiding mechanism 4 engages the first limiting end 413 of the guiding groove 41, and the protrusion 51 of the positioning mechanism 5 engages the recess 52. Accordingly, the blocking wall 26 limits the temple 3 at a particular angle and prohibits the temple from pivoting upwardly and excessively, and the guiding mechanism 4 and the positioning mechanism 5 position the temple 3 at the extending position stably.

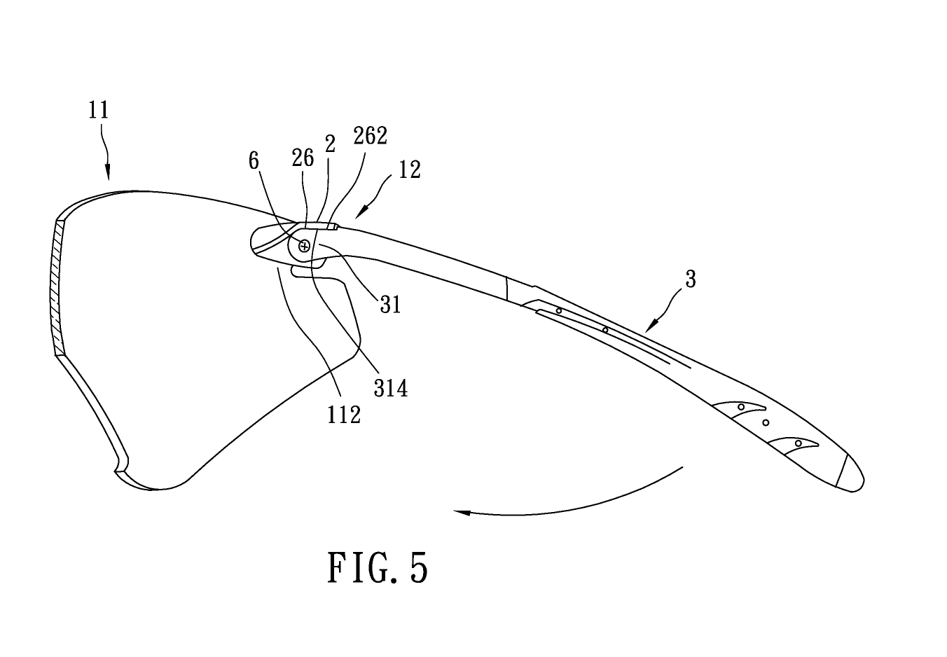

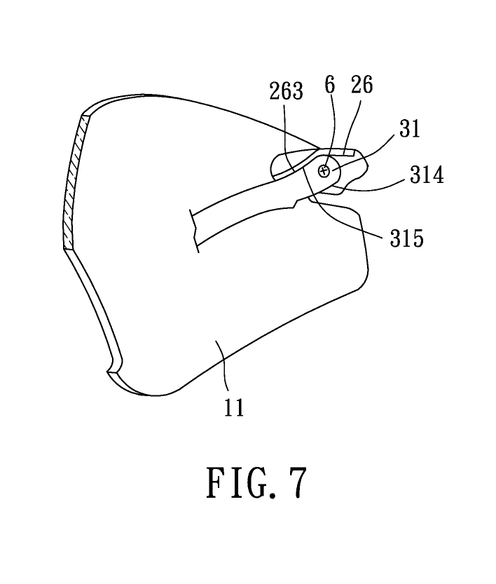

When it is desired to rotate the temple 3 from the extending position to the folded position as shown in FIGS. 6 and 7, a force has to be exerted to the temple 3 so as to release the engagement between the protrusion 51 and the recess 52 of the positioning mechanism 5 and the engagement between the pin 42 and the first limiting end 413 of the guiding mechanism 4. Then, as indicated by the arrow in FIG. 5, the temple 3 is rotated about the pivoting element 6 downwardly and the pin 42 slides along the guiding groove 41. When the bottom surface 315 of the pivoting part 31 of the temple 3 abuts against the front segment 263 of the blocking surface 261 of the blocking wall 26, the temple 3 is at the folded position. At this time, the pin 42 engages the second limiting end 414 of the guiding groove 41 of the guiding mechanism 4.

To sum up, the curvature of the temple 3 may be relatively greater for fitting a profile of the user's face, so that the curvatures of the temple 3 and the lens unit 11 substantially match with each other and the temple 3 is disposed behind and extends proximate to the lens unit 11 at the folded position. Thus, the eyeglasses of this invention occupy a relatively small space when folded. At the same time, stability of the eyeglasses when being worn by the user is enhanced since the curvature of the temple 3 is relatively greater.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A pair of eyeglasses comprising:
a lens unit including a pair of endpieces horizontally spaced apart from each other; and
a pair of temple members, each of which includes
a temple including a pivoting part pivoted to a corresponding one of said endpieces, said temple being pivotable upward and downward with respect to the corresponding one of said endpieces between an extending position, where said temple extends backwardly away from said lens unit, and a folded position, where said temple is disposed behind and extends proximate to said lens unit, and
a guiding mechanism for guiding and limiting said temple to pivot between the extending position and the folded position.

2. The pair of eyeglasses as claimed in claim 1, wherein each of said endpieces includes a plate portion having an outer side and an inner side, and a connecting element connected to said plate portion and including an outer wall and an inner wall that are spaced apart from each other and that are disposed respectively at said outer side and said inner side of said plate portion so as to sandwich said plate portion therebetween, said pivoting part of said temple being pivoted to said inner wall of said connecting element.

3. The pair of eyeglasses as claimed in claim 2, wherein each of said temple members further includes a pivoting element extending horizontally through and interconnecting said pivoting part of said temple, and said connecting element and said plate portion of the corresponding one of said endpieces.

4. The pair of eyeglasses as claimed in claim 3, wherein:
said plate portion of each of said endpieces is formed with a first through hole;
said outer wall of said connecting element is formed with a threaded hole registered with said first through hole, and said inner wall of said connecting element is formed with a second through hole registered with said threaded hole;
said pivoting part of said temple is formed with a third through hole registered with said second through hole;
said connecting element further includes an annular wall surrounding said second through hole and projecting inwardly from said inner wall into said third through hole; and
said pivoting element is a screw extending through said third through hole, said second through hole and said first through hole in sequence and screwed into said threaded hole.

5. The pair of eyeglasses as claimed in claim 2, wherein said guiding mechanism includes:
a guiding groove which is disposed at one of said inner wall of said connecting element and said pivoting part of said temple, and which includes a first limiting end, a second limiting end vertically opposite to said first limiting end, and a middle part disposed between and in spatial communication with said first limiting end and said second limiting end; and
a pin disposed at another one of said inner wall of said connecting element and said pivoting part of said temple, to engage said first limiting end of said guiding groove when said temple is at the extending position, and to engage said second limiting end of said guiding groove when said temple is at the folded position.

6. The pair of eyeglasses as claimed in claim 2, wherein:
said inner wall of said connecting element has an inner surface facing said pivoting part of said temple;
said connecting element further includes a blocking wall projecting inwardly from said inner surface of said inner wall, and including a blocking surface that faces said pivoting part of said temple and that has a front segment and a rear segment; and
said pivoting part of said temple includes a top surface and a bottom surface, one of which abuts against said rear segment of said blocking surface of said blocking wall when said temple is at the extending position, and the other one of which abuts against said front segment when said temple is at the folded position.

7. The pair of eyeglasses as claimed in claim 6, wherein:
said pivoting part of said temple further includes an abutting surface abutting against said inner surface of said inner wall of said connecting element; and
each of said temple members further includes a positioning mechanism including a recess which is disposed at one of said inner surface and said abutting surface, and a protrusion which is disposed at the other one of said inner surface and said abutting surface and which engages said recess when said temple is at the extending position.

8. The pair of eyeglasses as claimed in claim 2, wherein:
said inner wall and said outer wall of said connecting element have respective rear ends, and said connecting element further includes an interconnecting wall that interconnects said rear ends and that cooperates with said inner wall and said outer wall to define a clamping groove;
said plate portion of each of said endpieces of said lens unit is formed with an upper notch and a lower notch, and includes an insertion plate that is disposed between said upper notch and said lower notch and that is inserted into said clamping groove.

9. The pair of eyeglasses as claimed in claim 1, wherein said temple further includes a bend part extending from said pivoting part and having a thickness greater than a thickness of said pivoting part.

10. The pair of eyeglasses as claimed in claim 9, wherein the thickness of said pivoting part ranges from 1 mm to 3 mm.

11. The pair of eyeglasses as claimed in claim 1, wherein a curvature of said temple substantially matches with a curvature of said lens unit.
